(19) United States
(12) Patent Application Publication
(10) Pub. No.: US 2023/0378722 A1
(43) Pub. Date: Nov. 23, 2023

(54) SPARK PLUG FOR INTERNAL COMBUSTION ENGINES

(71) Applicant: PGES GmbH, Jenbach (AT)

(72) Inventors: David Axel HERDIN, Stockerau (AT); Rüdiger HERDIN, Ebreichsdorf (AT)

(73) Assignee: PGES GmbH, Jenbach (AT)

(21) Appl. No.: 17/913,539

(22) PCT Filed: Mar. 25, 2021
(86) PCT No.: PCT/EP2021/057743

§ 371 Date: Sep. 22, 2022

(30) Foreign Application Priority Data
Mar. 31, 2020 (AT) A 50262/2020

(51) Int. Cl. H01T 13/36; H01T 13/16

(52) U.S. Cl. CPC H01T 13/36; H01T 13/16

(57) ABSTRACT

A spark plug (1) for internal combustion engines has a center electrode (6) arranged along a central axis (2) of the spark plug (1), which electrode (6) is enclosed by an insulator (5) at least in portions, and a housing (9) in which the insulator (5) is received, at least in portions. A gap (20) is formed, at least in portions, between the insulator (5) and the housing (9). The gap (20) is at least partially filled with a material (23) having a thermal conductivity (λ)≥1 W/(m*K).

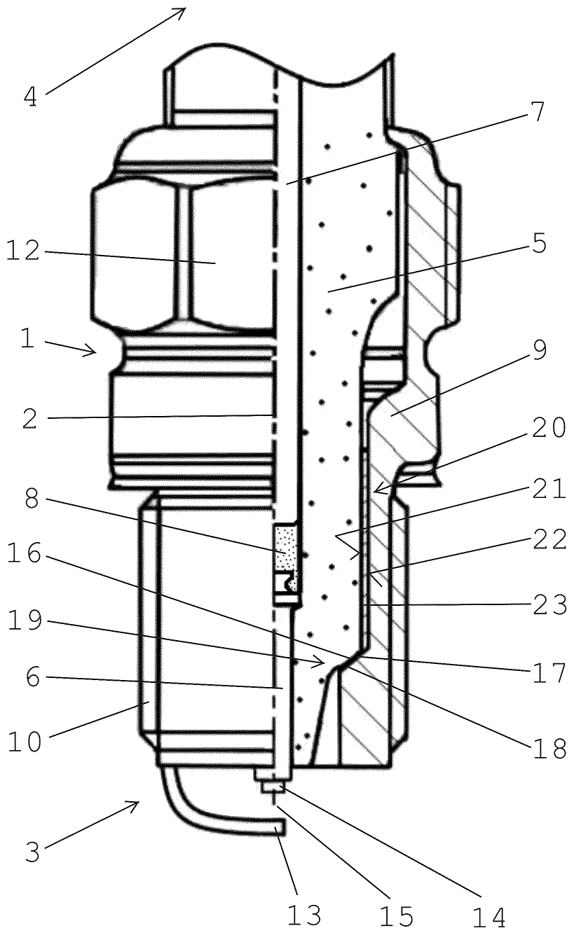

### TECHNICAL FIELD

The disclosure relates to a spark plug for internal combustion engines.

### BACKGROUND

With conventional spark plugs, a usually rod-shaped center electrode made of metal is enclosed by an insulator made of ceramic in such a manner that only the front part of the center electrode remains free. The insulator isolates the center electrode from a metal housing to which an outer electrode or ground electrode is attached. The insulator is enclosed by the housing at least in some regions, in particular in the region of the spark plug that faces the combustion chamber when the spark plug is installed. The housing has a thread for screwing in and an attachment, for example an attachment that is hexagonal in cross-section, for a tool wrench, such that the spark plug can be screwed firmly into a cylinder head and connected to it in this manner.

In some embodiments of spark plugs, the housing does not abut the insulator over a major length, but is spaced therefrom by a gap over a part of their longitudinal extension.

With conventional spark plugs, the narrow gap formed between the housing and the insulator is filled with air. To seal the gap to the combustion chamber, the insulator sits with a shoulder on an inner shoulder in the housing, wherein a sealing ring can be arranged between the inner shoulder and the insulator in order to seal the gap in a gas-tight manner. The region in which the insulator contacts the housing directly or indirectly via the sealing ring is the insulator seat.

### SUMMARY

The disclosure relates to a spark plug for internal combustion engines having a central electrode arranged along a central axis of the spark plug, which electrode is enclosed by an insulator at least in portions, and a housing in which the insulator is received, at least in portions, wherein a gap is formed, at least in portions, between the insulator and the housing.

To ignite the combustion gas contained in the combustion chamber, an ignition spark is formed between the exposed tip of the center electrode and the outer electrode or ground electrode, which is spaced apart from it by an ignition gap and connected to the housing. When the combustion gas is ignited and burned, temperatures of more than 1000° C. are generated in the combustion chamber, by which the tip of the center electrode can also be heated up to 1000° C. Normally, however, the tip of the center electrode reaches a temperature of 400° C. to 850° C.

With spark plugs of known design, the heat generated at the tip of the center electrode is transferred from the center electrode to the insulator via a glass seal arranged in the insulator and connected to the center electrode. Due to the air gap between the insulator, heat is transferred from the insulator to the housing almost exclusively via the insulator seat. From the housing, a smaller part of the heat is then dissipated to the surroundings and the largest part is dissipated via the thread to the cylinder head into which the spark plug is screwed.

Due to the limited installation space, the transfer surface between the insulator and the housing in the region of the insulator seat is relatively small, such that the heat flow between the insulator and the housing is also limited. Although this transfer surface can be increased by optimization, the potential for improvement is relatively small due to the design. The result is a thermal overload of the center electrode support and the precious metal electrode.

The disclosure is based on the object of providing a spark plug of the above-mentioned type that reduces this problem. In particular, a spark plug that allows improved heat exchange between the center electrode and the housing is to be provided.

This object is achieved with a spark plug having the features as claimed.

It is provided that the gap is at least partially filled with a material having a thermal conductivity λ≥1 W/(m*K).

With conventional spark plugs, the gap is filled with air, which has a relatively low thermal conductivity λ=0.0262 W/(m*K). Thus, with conventional spark plugs, hardly any heat can be transferred across the gap. As such heat transfer takes place almost exclusively via the very limited contact surface between the insulator and the housing in the region of the insulator seat. With the spark plug in accordance with the disclosure, since the material filled in the gap has a much higher thermal conductivity λ than air, heat can be transferred between the insulator and the housing over the entire length of the gap filled with the material. As such, the surface area for heat transfer is greatly increased, resulting in a significant increase in heat flow between the insulator and the housing.

The center electrode is circumferentially enclosed by the insulator and the insulator is circumferentially received in the housing, wherein preferably with a free end of the center electrode protrudes from the insulator and a rear end of the insulator protrudes from the housing.

The gap is substantially in the form of a hollow cylinder and, like the central axis, runs in the longitudinal direction of the spark plug.

In a particularly preferred embodiment, the material received in the gap has a thermal conductivity λ≥4 W/(m*K), preferably ≥6 W/(m*K). This results in an even higher heat exchange between the insulator and the housing.

In particular, the material is a metal or metal alloy. This is particularly advantageous, since metals are particularly good conductors of heat on the one hand, and on the other hand—in comparison with mineral and ceramic materials—are easy to melt and introduce into the gap.

The material can be, for example, a metal or alloy that is liquid at low temperature and has a low melting point, in particular a gallium-based alloy, preferably used in an alloy with indium, rhodium, silver, zinc and/or tin.

The material can also be a suspension comprising a liquid and particles dispersed therein. The liquid is, for example, an oil, in particular a silicone oil, and the particles may include, for example, aluminum, copper, graphite and/or silver components. The suspension preferably has a paste-like state at room temperature.

Metals and suspensions that are liquid at low temperature are particularly easy to introduce into the gap, penetrate even into small cracks and cavities, and thus prevent the formation of air chambers in the gap, which would have a negative effect on the thermal conductivity of the material.

It is particularly preferred if the material has a melting point <200° C., in particular a melting point Θ<100° C. This makes it particularly easy to introduce the material into the gap by prior melting. Since the temperature in the region of the gap during the operation of the spark plug is at least above 150° C., but more likely well above 200° C., the material with such a low melting point in the gap melts completely or at least partially. This causes the gap to be optimally filled with the material, creating the largest possible region for heat transfer between the insulator and the housing.

Preferred embodiments are those in which the material is a bismuth-based alloy. Such alloys have a particularly low melting point. Particularly preferably, the bismuth alloy Rose's metal can be used. Rose's metal has a thermal conductivity λ of 6-9 W/(m*K) and a melting point Θ of approximately 94-98° C. The advantage of bismuth alloys in general and Rose's metal in particular is that they are highly brittle due to their high bismuth content. As a result, the material filled in the gap cracks when it solidifies, is then substantially free of residual stress and therefore also releases barely any stress to the adjacent insulator.

The gap is formed between an outer side of the insulator and an inner side of the housing. It is particularly preferred if the outer side of the insulator and/or the inner side of the housing is coated at least in the region of the gap, wherein the coating has a high degree of wettability. For this purpose, the inner side of the housing and/or the outer side of the insulator is coated with a thin metal layer or with a metal-containing layer, for example. A high degree of wettability of the surface(s) results in the material received in the gap being particularly close to the surface(s) in the molten state—when introduced into the gap or when the spark plug is in operation—and thus the largest possible contact surface is formed for heat transfer between the material and the housing or insulator.

Furthermore, the outer side of the insulator and/or the inner side of the housing can have a surface-enlarging structure at least in the region of the gap. Such a structure can be formed, for example, by grooves or notches. Increasing the surface allows more heat to be transferred from the insulator to the material in the gap and from the material to the housing.

The spark plug has a front end directed toward a combustion chamber in an installed condition and a rear end directed away from the combustion chamber in an installed condition. In particular, the part of the gap filled with the material extends from the insulator seat in the region of the front end of the spark plug in the direction of the rear end.

In particular, the insulator is made of ceramic, for example, aluminum oxide, and the housing is made of metal, for example, steel.

Furthermore, an outer electrode is preferably arranged on the housing, which extends radially from the housing to the free end of the center electrode, such that an ignition gap is formed between the outer electrode and the center electrode. This design enables the use of conventional spark plug components, thereby reducing the cost of manufacturing the spark plug in accordance with the disclosure. In contrast to the manufacture of conventional spark plugs, only the highly heat-conductive material has to be additionally introduced into the gap during the manufacture of the spark plug in accordance with the disclosure.

Preferably, a sealing ring is arranged between the insulator and the housing in the region of the insulator seat. This sealing ring prevents combustion or explosion gas from entering the gap and the highly heat-conductive material from escaping into the combustion chamber.

Further details, features and advantages of the invention will be apparent from the following description with reference to the accompanying drawing, in which a preferred embodiment is shown.

### BRIEF DESCRIPTION OF THE DRAWING

The FIGURE shows a portion of a spark plug in a partially cut side view.

### DETAILED DESCRIPTION

In the FIGURE, the left side of spark plug 1 is shown uncut. The right side of the spark plug 1, on the other hand, is shown cut along a cutting plane that passes through a central axis 2 of the spark plug 1 and is parallel to the viewing plane.

The spark plug 1 has a front end 3 directed toward a combustion chamber of an internal combustion engine in the installed state and a rear end 4 directed away from the combustion chamber in the installed state.

An insulator 5 made of an electrically insulating material, in particular ceramic, extends from the front end 3 up to the rear end 4 of the spark plug 1.

An electrically conductive center electrode 6 and an electrically conductive connecting bolt 7 are arranged along the central axis 2. The center electrode 6 is almost completely enclosed and the connecting bolt 7 is at least partially enclosed by the insulator 5. The connecting bolt 7 can be connected to a current conductor (not shown).

An electrically conductive glass seal 8 received inside the insulator 5 is located between the center electrode 6 and the connecting bolt 7.

The insulator 5 is received in a metallic housing 9. This has an external thread 11 for screwing into a cylinder head and an external hexagon for attaching a tool.

In the region of the front end 3, in the illustrated embodiment of the spark plug, an outer electrode 13 is arranged on the housing 9, which protrudes from the housing 9 towards the central axis 2, such that an ignition gap 15 is formed between the outer electrode 13 and a free end 14 of the central electrode 6.

The insulator 5 has a shoulder 16 in the region of the front end 3 of the spark plug 1, which rests against an inner shoulder of the housing 9 either directly or via a sealing ring 17. Together, the shoulder 16 of the insulator 5 and the inner shoulder 18 of the housing 9 form the insulator seat 19.

Starting from the insulator seat 19 and extending in the direction of the rear end 4 of the spark plug 1, a gap 20 is formed between an outer side 21 of the insulator 5 and an inner side 22 of the housing 9. Thus, the gap 20 has the shape of a hollow cylinder arranged between the insulator 5 and the housing 9.

A thermally conductive material 23 is arranged in at least a part of the gap 20 adjacent to the insulator seat. The thermally conductive material 23 can be filled into the gap 20 in a molten state during the manufacture of the spark plug. Alternatively, the thermally conductive material 23 can be arranged in a solid or deformable state in the gap 20 during manufacture.

The heat-conducting material 23 arranged in the gap 20 is at least partially, but in particular completely, melted during operation, that is, when the internal combustion engine is running. It forms a good heat-conducting connection between the insulator 5 and the housing 9.

The outer side 21 of the insulator 5 and/or the inner side 22 of the housing 9 can/may have a specially shaped or machined surface, for example a surface with a very low surface roughness, such that it can be wetted very well.

Spark plugs 1 of a different design can also be used, as long as a heat-conducting material 23 is received, in particular filled, in the gap 20 between the insulator 5 and the housing 9.

### LIST OF REFERENCE SIGNS

1 Spark plug
2 Central axis
3 Front end
4 Rear end
5 Insulator
6 Center electrode
7 Connecting bolt
8 Glass seal
9 Housing
10 ---
11 External thread
12 Attachment point
13 Outer electrode
14 Free end of center electrode
15 Ignition gap
16 Shoulder
17 Sealing ring
18 Inner shoulder
19 Insulator seat
20 Gap
21 Outer side of insulator
22 Inner side of housing

1.-8. (canceled)

9. A spark plug (1) for internal combustion engines, comprising
a center electrode (6) arranged along a central axis (2) of the spark plug (1), the center electrode being at least in portions enclosed by
an insulator (5); and
a housing (9) in which the insulator (5) is received, at least in portions,
wherein a gap (20) is formed, at least in portions, between the insulator (5) and the housing (9), and
wherein the gap (20) is at least partially filled with a material (23) having a thermal conductivity (λ)≥1 W/(m*K).

10. The spark plug according to claim 9,
wherein the material (23) has a thermal conductivity (λ)≥4 W/(m*K).

11. The spark plug according to claim 9,
wherein the material (23) has a thermal conductivity (λ)≥6 W/(m*K).

12. The spark plug according to claim 9,
wherein the material (23) has a melting point (Θ)<200° C.

13. The spark plug according to claim 9,
wherein the material (23) has a melting point (Θ)<100° C.

14. The spark plug according to claim 9,
wherein the material (23) is a metal, a metal alloy, or a suspension comprising metal particles.

15. The spark plug according to claim 9,
wherein the material (23) is a bismuth alloy.

16. The spark plug according to claim 9,
wherein the material (23) is Rose's metal.

17. The spark plug according to claim 9,
wherein an outer side (21) of the insulator (5) and/or an inner side (22) of the housing (9) is coated at least in a region of the gap (20).

18. The spark plug according to claim 9,
wherein an outer side (21) of the insulator (5) and/or an inner side (22) of the housing (9) has, at least in a region of the gap (20), a structure that increases a surface of the outer side (21) and/or the inner side (22).

19. The spark plug according to claim 9,
wherein an outer side (21) of the insulator (5) and/or an inner side (22) of the housing (9) has, at least in a region of the gap (20), grooves or notches that increases a surface of the outer side (21) and/or the inner side (22).

20. The spark plug according to claim 9,
wherein the spark plug (1) has a front end (3) directed towards a combustion chamber in an installed state and a rear end (4) directed away from the combustion chamber in the installed state, and
wherein part of the gap (20) filled with the material (23) runs from an insulator seat (19) in a region of the front end (3) of the spark plug (1) towards the rear end (4).
